(19) United States
(12) Patent Application Publication
(10) Pub. No.: US 2011/0019946 A1
(43) Pub. Date: Jan. 27, 2011

(54) DAMPING DEVICE FOR DAMPING AN OPENING AND/OR CLOSING MOTION OF A FURNITURE FITTING

(76) Inventor: Bernhard KRAMMER, Hochst (AT)

Correspondence Address: WENDEROTH, LIND & PONACK, L.L.P., 1030 15th Street, N.W.,, Suite 400 East, Washington, DC, 20005-1503, US

(21) Appl. No.: 12/897,168

(22) Filed: Oct. 4, 2010

Related U.S. Application Data
(63) Continuation of application No. PCT/AT2009/000140, filed on Apr. 8, 2009.

(30) Foreign Application Priority Data
Apr. 11, 2008 (AT) A 573/2008

(51) Int. Cl. E05D 11/08; F16F 7/00; E05F 5/00; A47B 88/12

(52) U.S. Cl. 384/20; 188/266; 16/352

(57) ABSTRACT

The invention relates to a damping device for damping an opening and/or closing motion of a furniture fitting, wherein the damping device comprises a restoring mechanism, by which an actuating element of the damping device can be moved into a starting position of the subsequent damping stroke after damping has been carried out, wherein the location of the starting position of the actuating element can be set relative to the damping device by an adjusting unit. The actuating element of the damping device is rotatably supported, wherein the adjusting unit can be used to adjustably limit the restoring stroke of the actuating element relative to the damping device.

The present invention relates to a damping device for damping an opening and/or closing movement of a furniture fitting, wherein the damping device has a return mechanism, by which an actuating element of the damping device is movable after damping has been effected into a starting position for the next damping stroke, wherein the location of the starting position of the actuating element is adjustable relative to the damping device by an adjusting device.

The invention further concerns a furniture fitting as well as an article of furniture having a damping device of the kind to be described.

It is known in the state of the art for furniture fittings to be equipped with a damping device so that a damped movement of the movable furniture part into at least one of the two end positions can take place. In that case an actuating element associated with the damping device is acted upon by an abutment portion or by the movable furniture part itself, as from a given relative position of the furniture fitting, and that initiates the beginning of the damping operation. In addition there is also provided a return mechanism by which the actuating element can be movable into a starting position for the next damping stroke again after damping has occurred. When using furniture fittings with integrated damping however it can happen that the furniture part to be moved is braked excessively so that the resulting closing or opening time for the movable furniture part exceeds a tolerable amount. In the extreme case it is even possible that no complete movement of the movable part at all towards the desired end position is possible. If two furniture fittings are arranged for guided movement of a movable furniture part, it would basically be possible for the first furniture fitting of the movable furniture part to be equipped with a damping function while the second furniture fitting does not have a damping device. In the sense of a movement characteristic which is as optimum as possible however, exact adaptation to the respective weight of the furniture part to be moved is not possible in that fashion.

WO 2007/009899 A1 and WO 2007/009902 A1 disclose furniture hinges with a linear damper for damping a hinge movement. The linear damper in that case includes a cylinder and a piston which is linearly displaceable in the cylinder and which has a piston rod coupled thereto, wherein the length of the stroke of the piston rod relative to the cylinder is adjustable. The field of use described in those publications is limited to linear dampers.

The object of the present invention is to provide a damping device of the general kind referred to in the opening part of this specification, while avoiding the foregoing disadvantages.

In accordance with the invention in an advantageous configuration that is achieved in that the actuating element of the damping device is rotatably supported, wherein the return stroke of the actuating element can be adjustably limited relative to the damping device by the adjusting device.

Accordingly therefore the return stroke of a rotatable actuating element of the damping device is adjustably limited. Thus, the return movement of the actuating element of the damping device can be limited by the adjusting device, whereby the length of the damping stroke can be varied. Accordingly the return stroke of the actuating element relative to the damping device can be reduced by the adjusting device.

In accordance with an embodiment of the invention it can be provided that the return stroke of the actuating element can be altered relative to the damping device stepwise, preferably at predetermined positions, by the adjusting device. In that case the actuating element can be latched at various defined positions, in which case the location of those predetermined positions corresponds to a partial travel movement of the maximum damping stroke of the actuating element. The actuating element is then movable starting from an end position over a limited path of movement towards the arresting effect predetermined by the adjusting device, and in the reverse direction.

In accordance with a further embodiment of the invention it can be provided that the return stroke of the actuating element can be substantially completely deactivated relative to the damping device by the adjusting device. In that way the actuating element—preferably after damping has been effected—can be arrested in that end position so that the actuating element cannot be returned at all. Such a construction can provide that the damping device of the furniture fitting can be taken entirely out of operation.

The damping device can have at least two damping components which are mounted movably relative to each other in a damping stroke, wherein the actuating element is operatively connected to one of the two damping components at least in the damping stroke. In that respect it can be provided that the actuating element can be arrested by the adjusting device in various rotary positions.

Fluid dampers, in particular rotational dampers, can be provided as the damping device, in which case all damping media known in the state of the art such as for example silicone oils can be used.

The return mechanism can include at least one spring by which the actuating element can be moved back into a starting position for the next damping stroke again after damping has occurred in order at the end of the damping stroke to permit a return stroke, at the end of which the actuating element or the damper and its damping components have again assumed a starting position for the next damping stroke. The return mechanism can also have a freewheel mode, wherein there can be provided an arresting device having an arresting position and a freewheel position. The return mechanism can also be formed by a valve structure of a damping device which permits a return flow of the damping fluid after damping has occurred and thus a return movement of the actuating element. Such return mechanisms however are known in the state of the art and do not need to be described in greater detail at this juncture.

The furniture fitting according to the invention can be either in the form of a furniture hinge, an extension guide for drawers or an adjusting mechanism for a furniture flap. In that respect the damping device in question can be so arranged that it damps a relative movement—in particular a linear movement and/or a pivotal movement—of at least two abutment portions to be fixed to a furniture part. In that respect, in the case of furniture hinges, the relative movement of the hinge cup to the hinge arm can be damped, in the case of an extension guide for drawers the relative movement of two rails can be damped and in the case of an adjusting mechanism the pivotal movement of an adjusting arm provided for movement of the furniture flap can be damped. For reasons of simplicity the arrangement of a damping device on a furniture hinge is illustrated in the accompanying Figures. It will be directly apparent to the man skilled in the relevant art, on the basis of the illustrated embodiments, how the arrangement of the damping device on an extension guide fitment for drawers or on an adjusting mechanism for the movement of a furniture flap is to be implemented.

The article of furniture according to the invention is characterized by a furniture fitting having a damping device of the kind in question.

Further details and advantages of the present invention are described with reference to the specific description hereinafter. In the drawing:

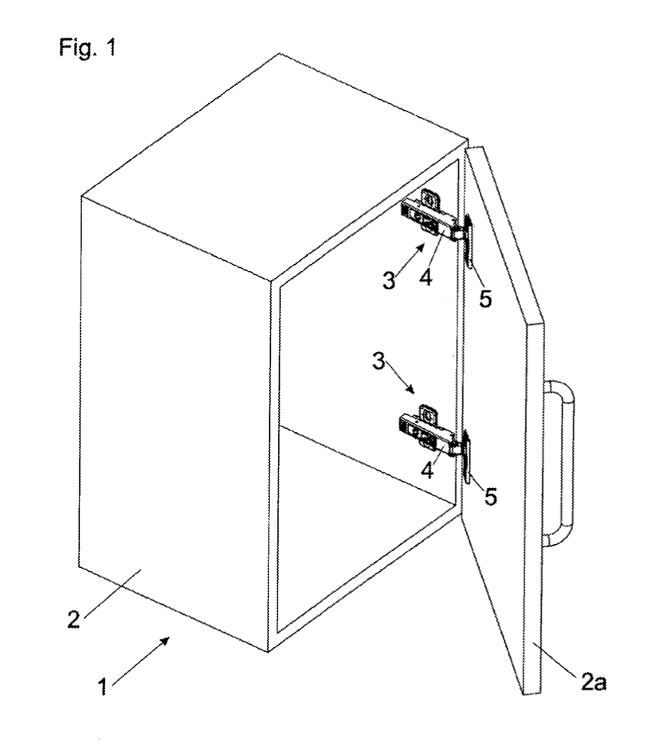

FIG. 1 shows a perspective view of an article of furniture having a movable furniture part pivotably mounted to the furniture carcass by two furniture hinges,

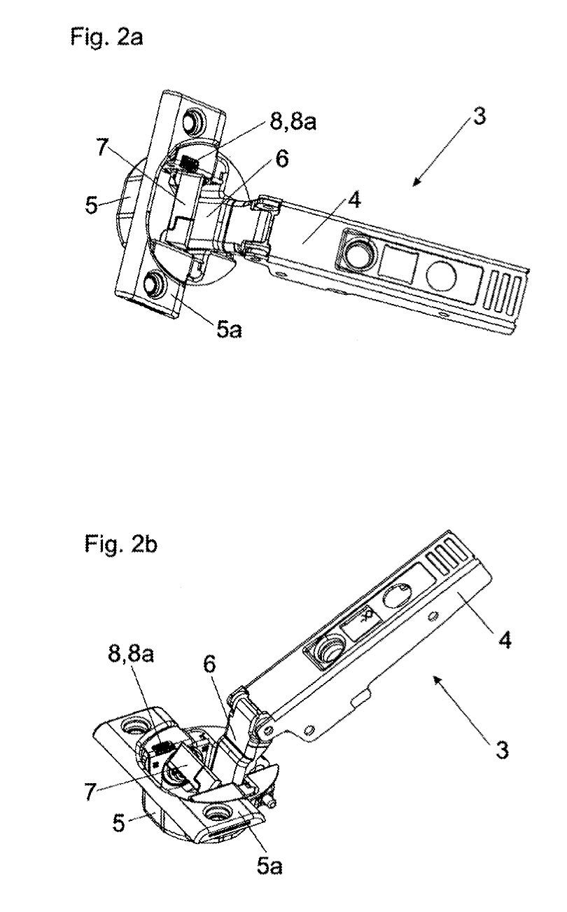

FIGS. 2a and 2b show various perspective views of the furniture hinge,

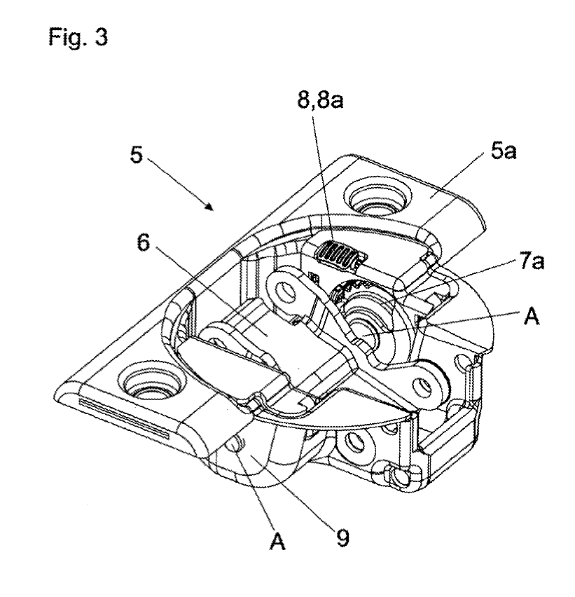

FIG. 3 shows the hinge cup with the hinge arm removed,

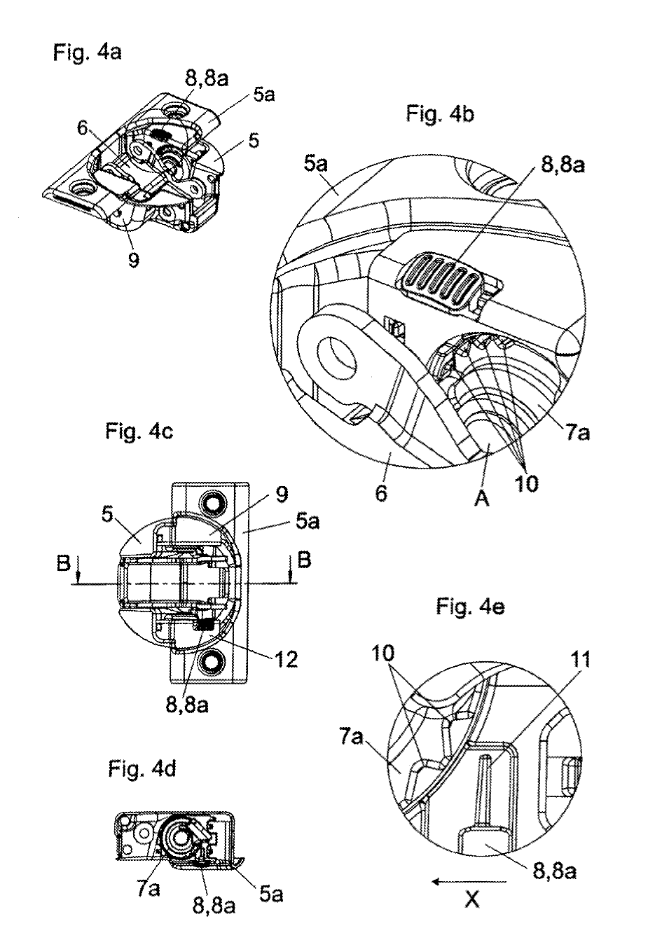

FIGS. 4a-4e show various views of the hinge cup with the adjusting device for limiting the return stroke of the actuating element,

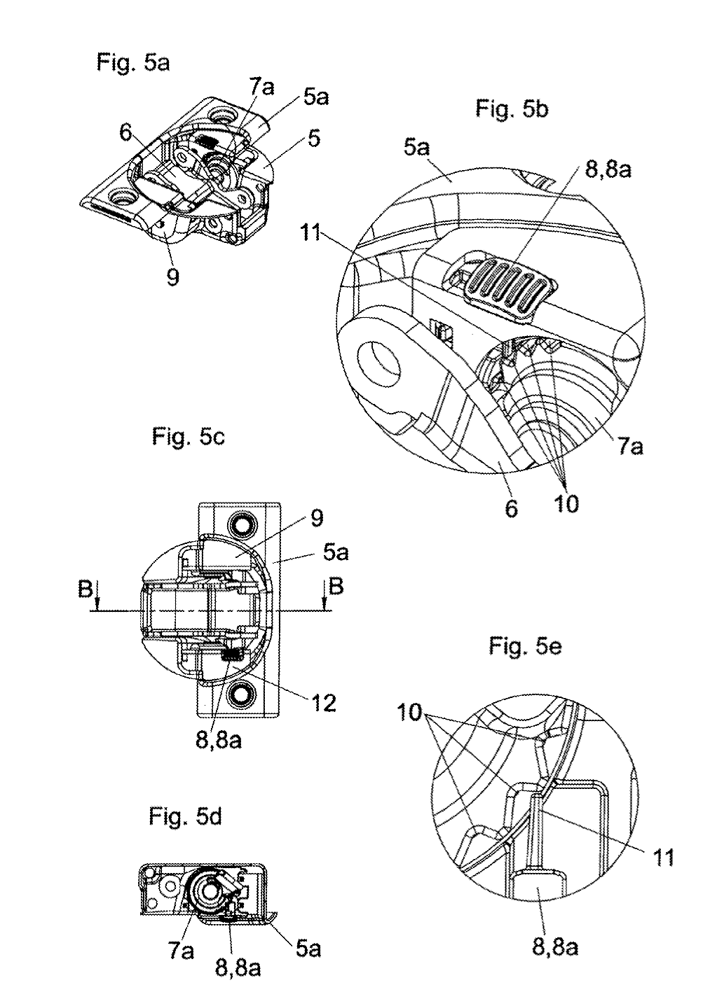

FIGS. 5a-5e show similar views to FIGS. 4a through 4e with a limited actuating element damping stroke,

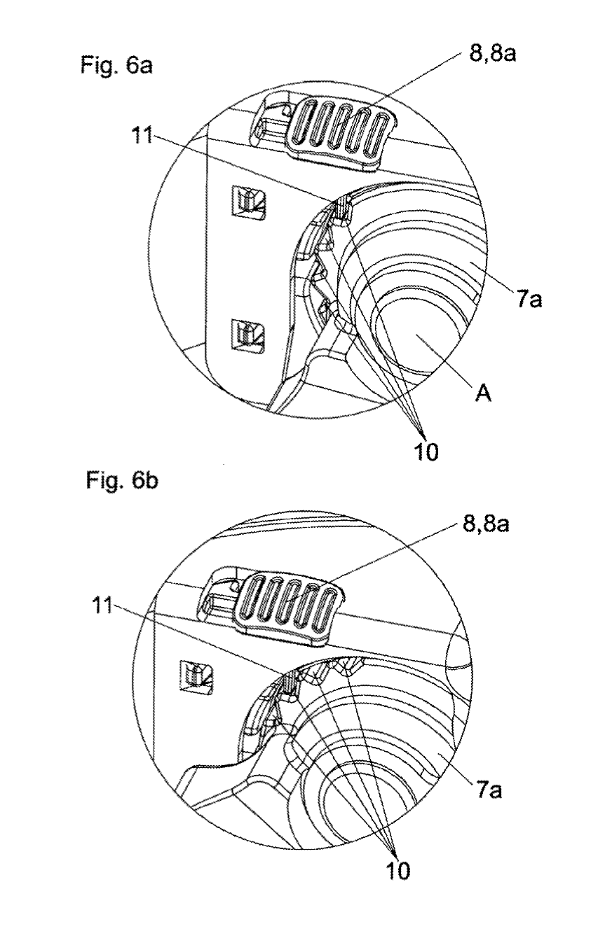

FIGS. 6a and 6b show various starting positions of the actuating element,

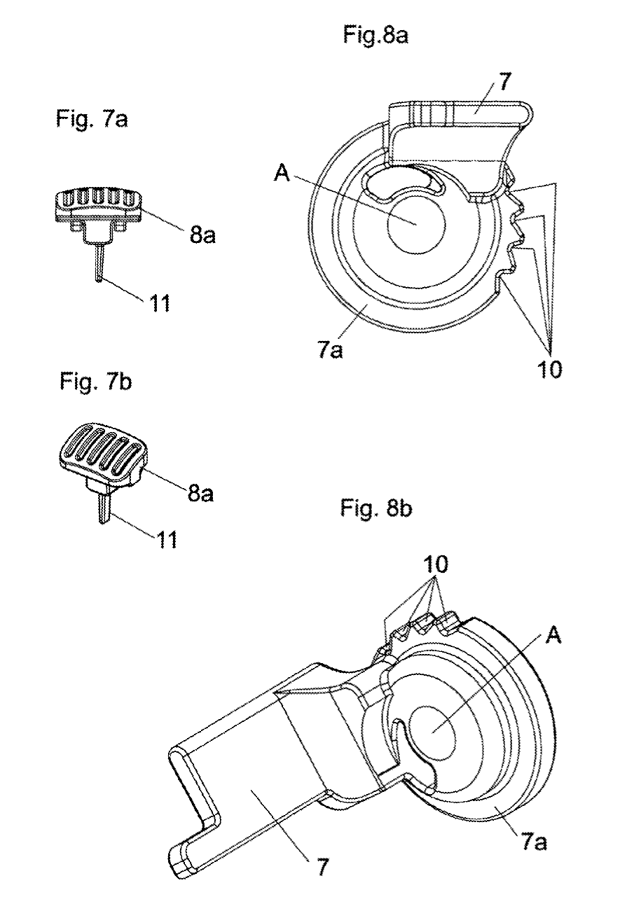

FIGS. 7a and 7b show various views of a switch of the adjusting device having an arresting element,

FIGS. 8a and 8b show various views of the actuating element and the associated rotor of the return mechanism,

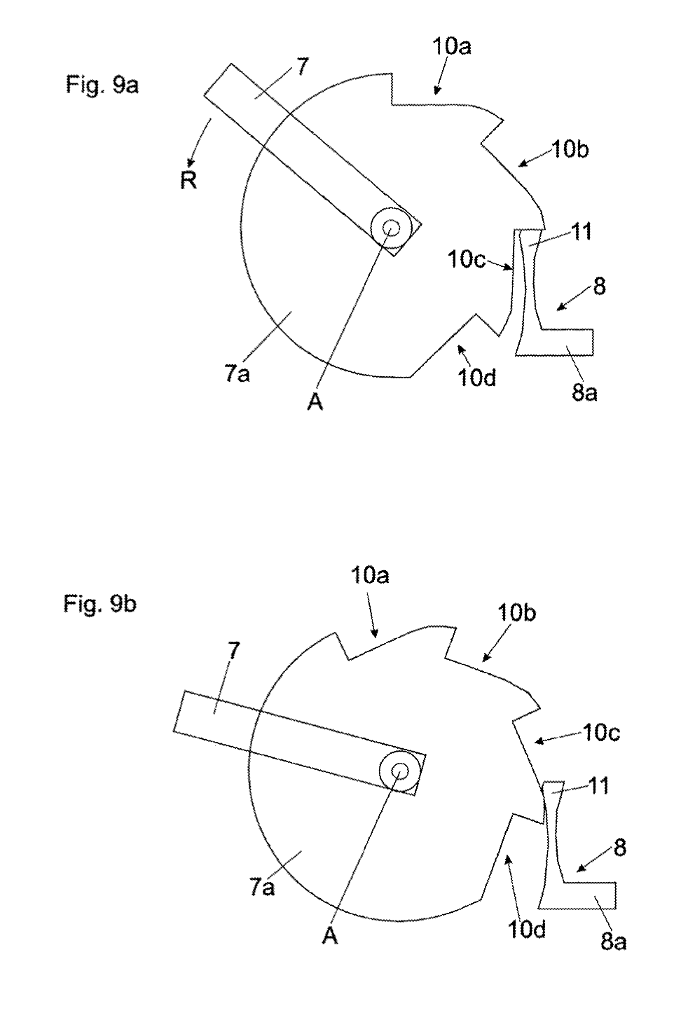

FIGS. 9a and 9b show highly diagrammatic views of the rotor having an arresting element in a recess for limiting the return of the rotor at the beginning and at the end of the damping stroke,

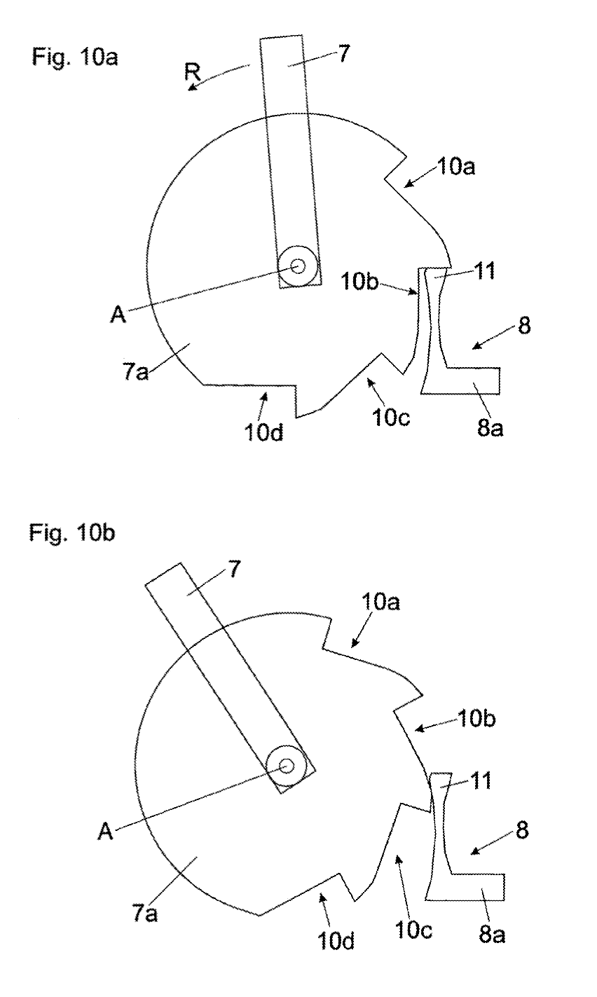

FIGS. 10a and 10b show views similar to FIGS. 9a and 9b, with the arresting element arresting the rotor in a direction of rotation in a different recess,

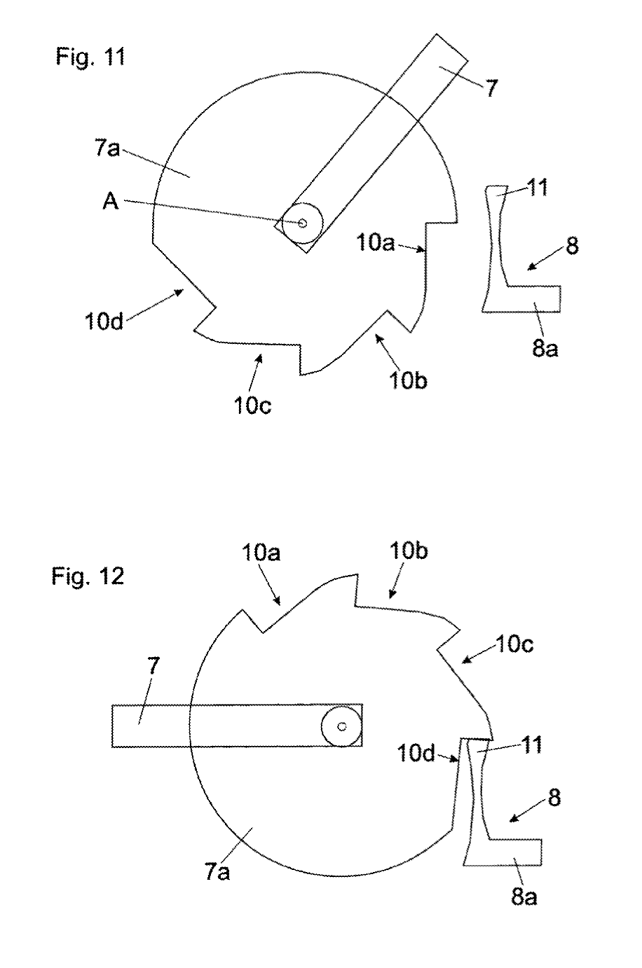

FIG. 11 shows the rotor with an arresting element out of engagement, wherein the maximum damping action of the damping device is available, and

FIG. 12 shows an actuating element which is manually pressed into the hinge cup and which is arrested in that position by the arresting element of the switch whereby the damping action of the damping device is completely deactivated.

FIG. 1 shows a perspective view of an article of furniture 1 having a furniture carcass 2 to which furniture fittings in the form of furniture hinges 3 for pivotably mounting a movable furniture part 2a are mounted. Both furniture hinges 3 have a hinge arm 4 to be fixed to the furniture carcass 2 and a hinge cup 5 which is hingedly arranged thereon and which is recessed in a bore provided on the rear side of the movable furniture part 2a. Depending on the respective size and weight of the movable furniture part 2a it can happen that the closing time or the opening time in respect of the damping action exceeds a tolerable amount so that the damping effect in the direction of one of the two end positions of the movable furniture part 2a inadequately satisfies the wish for an optimized movement characteristic. In addition the furniture hinges 3 have a return mechanism (not visible in greater detail here) for an actuating element, wherein the return movement of the actuating element is adjustably limited by an adjusting device which is still to be described. In that way damping is effected only over a part of the damping range provided as standard.

FIGS. 2a and 2b each show a furniture hinge 3 in different perspective views. The furniture hinge 3 has a hinge arm 4 and a hinge cup 5 which is pivotably connected together by way of at least one hinge lever 6. The hinge cup 5 includes a per se known fixing flange 5a. It is possible to see an actuating element 7 of a damping device of the furniture hinge 3, which is supported rotatably within the hinge cup 5. The actuating element 7 of the damping device in the illustrated Figure is in a readiness position for a damping stroke. As from a certain closed position of the furniture hinge 3 the outer hinge lever 6 encounters the rotatable actuating element 7, and that initiates the beginning of the damping stroke. In a further closing movement the actuating element 7 is pushed completely into the hinge cup 5 by the hinge lever 6, wherein that pivotal movement of the actuating element 7 is damped by the damping device (not visible in greater detail here) so that the hinge movement also takes place in damped relationship to the completely closed position. The Figure also diagrammatically indicates an adjusting device 8 having a switch 8a which is arranged on the hinge cup 5 and by which the location of the starting position of the actuating element 7 relative to the damping device is adjustable. In that way the return movement of the actuating element 7, starting from the completely pushed-in position, can be adjustably limited. In the illustrated embodiment the switch 8a is linearly displaceable and includes at least two switching positions, wherein one switching position can permit complete return of the actuating element 7 and a further switching position can permit a limited return movement of the actuating element 7 after damping has occurred. Equally the damping device can be substantially completely deactivated by the adjusting device 8. For reasons of precise adaptation however it may be advantageous to allow a return function of the actuating element over a limited part of the complete return movement, by the adjusting device, whereby damping is also effected only over a part of the complete damping range.

FIG. 3 shows a perspective view of the hinge cup 5, with the hinge arm 4 being omitted for the sake of clarity. In the illustrated Figure the actuating element 7 is concealed by the hinge lever 6 acting thereon, wherein the actuating element 7 which is pivotable about axis of rotation A is disposed in a pushed-in position relative to the hinge cup 5. Associated with the actuating element 7 is a rotor 7a which also forms part of a return mechanism for the return of the actuating element 7. The rotor 7a of the return mechanism is mounted diametrally with respect to a damping device 9 on the hinge cup 5, wherein the rotor 7a with the return mechanism and the damping device 9 are respectively disposed at an outside wall which is a lateral wall in the mounting position and, in the mounting position, beneath the fixing flange 5a of the hinge cup 5. Damping of the actuating element 7 is therefore effected by the damping device 9 while the return of the actuating element 7 is effected by means of the rotor 7a of the return mechanism. The return mechanism can include for example a torsion spring by which the rotor 7a can be turned back into a starting position again for the next damping stroke, after damping has occurred, by the loaded torsion spring. At its outside peripheral surface the rotor 7a has a plurality of toothed configurations or recesses into which an arresting element that is still to be described of the adjusting device 8 can engage. The adjusting device 8 with the switch 8a is disposed in the illustrated Figure in a position in which unimpeded return movement of the rotor 7a (and therewith the actuating element 7) is possible.

FIG. 4a shows essentially the same view as FIG. 3. FIG. 4b shows the region circled in FIG. 4a, on an enlarged scale. The rotor 7a which is non-rotatably connected to the actuating element 7 can rotate about the axis of rotation A during the damping operation and during the return movement respectively. The rotor 7a is provided with recesses 10 into which an arresting element 11 (not visible in greater detail here) of the adjusting device 8—preferably of the switch 8a—can engage. In the illustrated Figure however the switch 8a is in a position which permits unimpeded return movement of the rotor 7a and the actuating element 7 formed thereon. FIG. 4c shows a plan view of the top side of the hinge cup 5. Provided beneath the fixing flange 5a is a damping device 9 and a diametrally opposite return mechanism 12, which can be arranged as mutually separate units on the hinge cup 5. It will be appreciated that it is also possible for the damping device 9 and the return mechanism 12 to be integrated in a common unit. FIG. 4d shows a sectional view along section line B-B in FIG. 4c. FIG. 4e shows the region circled in FIG. 4d of the adjusting device 8 on an enlarged scale. It is possible to see the rotor 7a with its recesses 10. The partly visible switch 8a includes a resilient arresting element 11, wherein in a movement of the switch 8a, in the direction of the arrow X, the arresting element 11 can be parked into one of the recesses 10 whereby further movement of the rotor 7a in the direction of the open position is blocked but a return movement towards the completely closed position is possible. Depending on the respective recess 10 in which the arresting element 11 is parked, the return movement of the rotor 7a (and therewith the actuating element 7) is also adjustably limited.

FIGS. 5a through 5e show similar views to FIGS. 4a through 4e with the difference that now the switch 8a of the adjusting device 8 has been displaced into another switching position. It is apparent in particular from the enlarged-scale detail view in FIG. 5b that a resilient arresting element 11 formed on the switch 8a engages into one of the recesses 10 in the rotor 7a. The rotor 7a and the actuating element 7 connected thereto can therefore now only be moved within a limited rotary angle range which extends between the completely pushed-in position of the actuating element 7 and the latching position between the arresting element 11 and the respective recess 10 in the rotor 7a. It will be seen from FIG. 5e that the adjusting device 8 with the switch 8a has been displaced towards the left in comparison with FIG. 4e so that the resilient arresting element 11 is in an engagement position with one of the recesses 10 in the rotor 7a.

FIGS. 6a and 6b show similar views to FIG. 5b, with the switch 8a in FIG. 6a being in engagement with the uppermost recess 10 of the rotor 7a. That corresponds to the fully pushed-in position of the actuating element 7. By virtue of the arresting effect in that position, the rotor 7a can no longer be moved by the return mechanism 12 into a starting position for a damping stroke whereby the damping function of the furniture hinge 3 is completely deactivated. FIG. 6b shows a latching position which altered in relation to FIG. 6a between the arresting element 11 and the rotor 7a, whereby the actuating element 7 is movable over approximately half of the damping stroke provided as standard, and can thus at least partially provide a damping force. It is also apparent that the switch 8a can also be actuated in a further open position of the furniture hinge 3 by virtue of the resilient configuration of the arresting element 11, in which case the arresting element 11 runs on the outside peripheral surface of the rotor 7a. In the region of the recesses 10 the arresting element 11 can pass over the recesses 10 in the rotor 7a in one direction, but they block the rotor 7a in the opposite direction. In that way the actuating element 7 can be latched gradually (in the desired position) in the direction of the end position (starting from FIG. 6b towards FIG. 6a).

FIGS. 7a and 7b show a side view and a perspective view of the switch 8a of the adjusting device 8. It is possible to see an arresting element 11 or latching portion in the form of a peg which is injection molded in place and which can engage into recesses 10 in the rotor 7a. The resilient arresting element 11 can also have a mechanical spring element which is operative in the direction of the arresting position.

FIG. 8a shows a side view of the rotor 7a with the actuating element 7 formed thereon for the damping device 9 (not shown here). It is possible to see the recesses 10 for the arresting element 11. The rotor 7a is mounted about the axis of rotation A (see FIG. 3). Starting from the end position of the rotor 7a it can be moved by a return spring (not shown here) of a return mechanism in a starting position for the next damping stroke. FIG. 8b shows a perspective view of the actuating element 7 with the rotor 7a formed thereon and its recesses 10. The free end of the actuating element 7 can be connected, preferably latched, to a damping component of the damping device 9.

FIGS. 9a through 12 show a highly diagrammatic embodiment of a rotatable rotor 7a and the actuating element 7 non-rotatably connected thereto, wherein a possible operating principle of the invention will be described by means of the description hereinafter.

FIG. 9a shows the adjusting device 8 with the switch 8a with the arresting element 11 arranged thereon. The rotor 7a includes a plurality of recesses 10a-10d provided for adjustably limiting the return stroke. That provides that the return mechanism 12 (FIG. 9c) which is not visible here can only move the rotor 7a back over a part of the maximum available return stroke. In the illustrated position in FIG. 9b the arresting element 11 is in the recess 10c of the rotor 7a so that the rotor 7a is movable about its axis of rotation A only in the closing direction (that is to say in the counter-clockwise direction). Starting from the position shown in FIG. 9a the actuating element 7 is rotatable in the direction of the arrow R (closing direction) by virtue of actuation by the hinge lever 6 of the furniture hinge 3 until the actuating element 7 assumes the position shown in FIG. 9b. The movable furniture part 2a has already reached the completely closed position in FIG. 9b. In that case the rotor 7a however only moves so far relative to the stationary arresting element that throughout the entire damping stroke the arresting element 11 moves exclusively within the tooth width of the recess 10c and cannot latch into the next recess 10d. The rotor 7a is therefore rotated together with the actuating element 7 through for example 25°, whereupon the damping stroke is already concluded. The rotary movement of the rotor 7a is limited by the movable furniture part 2a abutting against the furniture carcass 2 (that is to say by reaching the closed position of the movable furniture part 2a). It is also to be stated in this context that the rotary angle range covered in respect of the movable furniture part 2a is a multiple higher than the rotary angle range covered in respect of the rotor 7a. Starting from the completely closed position of the movable furniture part 2a (FIG. 9b) the rotor 7a (and therewith the actuating element 7) are rotated back again by the return mechanism 12 (FIG. 9c), but only as far as the rotary position shown in FIG. 9a as the adjusting device 8 (switch 8a with arresting element 11) prevents a further return movement of the rotor 7a.

FIGS. 10a and 10b show the switch 8a with the arresting element 11 which in contrast to FIG. 9a is within the recess 10b. The actuating element 7 is movable by virtue of actuation by the hinge lever 6 (FIG. 2b) in the direction of the illustrated arrow R (closing direction) about the axis of rotation A, in which case the movable furniture part 2a (not visible here) is already in the completely closed position in FIG. 10b. Throughout the entire damping stroke the arresting element 11 is moved exclusively within the tooth width of the recess 10b and cannot jump into the recess 10c as the fact of the movable furniture part 2a butting against the furniture carcass 2 prevents further rotary movement of the rotor 7a. The desired residual damping power of the damping device 9 is therefore substantially constant (for example 20% of the total damping power)—irrespective of the recess 10a-10d in which the arresting element 11 is disposed. In principle therefore just a single recess 10 in the rotor 7a would be sufficient. The provision of a plurality of recesses 10a-10d however affords the possibility of providing a suitable latching engagement option for the arresting element 11 in the event of deviating installation positions in respect of the furniture hinge 3, deviating end positions in respect of the movable furniture part 2a and/or deviating relative positions of the individual components of the furniture hinge 3 with respect to each other. It should be noted that the damping power can be specifically and targetedly influenced by tooth configurations of varying sizes (that is to say by virtue of the shape and size, of the recesses 10a through 10d). Greater residual damping powers can also be achieved by virtue of a coarser tooth arrangement (that is to say larger rotary angle ranges in respect of the recesses 10a through 10d), and vice-versa.

FIG. 11 shows the switch 8a, the arresting element 11 being not at all in operative relationship with the rotor 7a. The actuating element 7 with the rotor 7a can therefore be unimpededly rotated during the damping stroke, wherein the entire damping power of the damping device 9 is available for damping the movable furniture part 2a. To adjust the location of the damping position of the actuating element 7 the switch 8a is displaced in the direction of the arresting position starting from FIG. 11. Upon a closing movement of the movable furniture part 2a the outer round peripheral edge of the rotor 7a firstly runs against the arresting element 11, upon a further closing movement the arresting element 11 can pass into one of the provided recess 10a-10c, depending on which respective recess 10a-10c corresponds to the completely closed position of the movable furniture part 2a. In the subsequent opening movement of the movable furniture part 2a the rotor 7a can be moved back by the return mechanism 12 only as far as the radially extending abutment of the respective recess 10a-10c. In the next damping stroke the arresting element 11 can only move within the previously determined recess 10a-10c whereby the desired residual damping power can be implemented. To restore the entire damping power the switch 8a is moved manually back into the release position so that the rotor 7a is again unimpededly rotatable.

FIG. 12 shows the completely deactivated damping function of the damping device 9, wherein the arresting element 11 of the switch 8a is in the last recess 10d. That position is preferably possible only by a specifically targeted and intentionally implemented manipulation, for example when the pivotably supported actuating element 7 (FIG. 2b) is intentionally pushed with a finger completely into the hinge cup 5 and in that case also moves the switch 8a in the direction of the arresting position. The damping device 9 is therefore completely ineffective in that position.

The present invention is not limited to the illustrated embodiments but includes or extends to all variants and technical equivalents which can fall within the scope of the appended claims. The positional details adopted in the description such as for example up, down, lateral and so forth are related to the directly described and illustrated Figure and are to be appropriately transferred to a fresh position upon a change in position. For the sake of simplicity a damped movement in the closing direction has been shown in the illustrated embodiments and likewise the described structures can also be used for opening damping of a furniture fitting. By virtue of the described structures—with reference to FIG. 1—one of the two furniture hinges 3 can permit a complete return movement of the actuating element 7 while the other furniture hinge 3 allows the return movement of the actuating element 7 only in part or not at all so that the closing and/or opening time of the movable furniture part 2a can be optimized.

1. A damping device for damping an opening and/or closing movement of a furniture fitting, comprising a return mechanism by which an actuating element of the damping device is movable after damping has been effected into a starting position for the next damping stroke, wherein the location of the starting position of the actuating element is adjustable relative to the damping device by an adjusting device, wherein the actuating element of the damping device is rotatably supported, wherein the return stroke of the actuating element can be adjustably limited relative to the damping device by the adjusting device.

2. The damping device according to claim 1, wherein the return stroke of the actuating element can be altered relative to the damping device stepwise at predetermined positions by the adjusting device.

3. The damping device according to claim 1, wherein the return stroke of the actuating element can be substantially completely deactivated relative to the damping device by the adjusting device.

4. The damping device according to claim 1, wherein the actuating element of the damping device can be arrested by the adjusting device.

5. The damping device according to claim 1, wherein the actuating element can be arrested by the adjusting device in various, rotary positions.

6. The damping device according to claim 1, wherein the adjusting device has a manually actuable switch with an arresting element, wherein the actuating element can be arrested by the arresting element.

7. The damping device according to claim 6, wherein the actuating element or a rotor thereof has one or more recesses into which the arresting element can engage.

8. The damping device according to claim 6, wherein the arresting element has a resilient or spring-loaded latching portion.

9. The damping device according to claim 6, wherein the switch has at least two switching positions.

10. The damping device according to claim 6, wherein the switch is linearly displaceable.

11. The damping device according to claim 1, wherein the actuating element of the damping device can be acted upon by a hinge lever of the furniture fitting.

12. The damping device according to claim 1, wherein the return mechanism includes at least one spring.

13. The damping device according to claim 1, wherein the damping device and the return mechanism are arranged as separate units on a furniture fitting.

14. A furniture fitting having a damping device according to claim 1.

15. The furniture fitting according to claim 14, wherein the furniture fitting is a furniture hinge.

16. The furniture fitting according to claim 15, characterized in that the furniture hinge has a hinge cup, the actuating element being mounted rotatably with respect to the hinge cup.

17. The furniture fitting according to claim 15, characterized in that the actuating element can be acted upon by a hinge lever of the furniture hinge as from a predetermined relative position of the furniture hinge.

18. The furniture fitting according to claim 14, wherein the furniture fitting is an extension guide for drawers.

19. The furniture fitting according to claim 14, wherein the furniture fitting is an adjusting mechanism for a furniture flap.

20. An article of furniture having a furniture fitting according to claim 14.
